(19) United States
(12) Patent Application Publication
(10) Pub. No.: US 2010/0282593 A1
(43) Pub. Date: Nov. 11, 2010

(54) RECOVERY OF HIGH WATER FROM PRODUCED WATER ARISING FROM A THERMAL HYDROCARBON RECOVERY OPERATION USING VACCUM TECHNOLOGIES

(76) Inventors: Brian C. Speirs, Calgary (CA); James Andrew Dunn, Calgary (CA)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/678,091

(22) PCT Filed: Oct. 9, 2008
(86) PCT No.: PCT/US08/79401

§ 371 Date: Jun. 29, 2010

(30) Foreign Application Priority Data
Nov. 2, 2007 (CA) 2,609,859

(51) Int. Cl. C02F 1/04; C02F 101/32

(52) U.S. Cl. 203/11; 202/185.1

(57) ABSTRACT

A method for reducing and re-using waste heat and water resulting from thermal hydrocarbon recovery operations involving accessing a hot water stream produced in a thermal hydrocarbon recovery operation; vaporizing water from the water stream by applying a vacuum, thereby producing water vapor; and condensing the water vapor to produce high quality water. A system is described including a hot water intake interfacing with a hot water stream from a thermal hydrocarbon recovery operation; a vaporization module receiving the hot water stream from the hot water intake, comprising a vacuum chamber in which a vacuum is applied to produce water vapor from the hot water stream; a condensation module in which water vapor produced in the vaporization module is condensed to form high quality water; and a water outlet for releasing the high quality water from the condensation module for re-use within the thermal hydrocarbon recovery operation.

### CROSS-REFERENCE TO RELATED APPLICATION

This application claims priority from Canadian Patent Application number 2,609,859 which was filed on 02 Nov. 2007, which is incorporated herein by reference.

### FIELD OF THE INVENTION

The present invention relates generally to a method and system for recovering high quality water, suitable for use as boiler feedwater, from produced water.

### BACKGROUND OF THE INVENTION

Thermal operations for bitumen or heavy oil recovery, such as steam assisted gravity drainage (SAGD) or cyclic steam stimulation (CSS), or derivatives thereof, produce large quantities of low temperature waste heat. Examples of thermal in situ recovery processes include but are not limited to steam-assisted gravity drainage (SAGD), cyclic steam (SA-stimulation (CSS), and various derivatives thereof, such as solvent-assisted SAGD SAGD), steam and gas push (SAGP), combined vapor and steam extraction (SAVEX), expanding solvent SAGD (ES-SAGD), constant steam drainage (CSD), and liquid addition to steam for enhancing recovery (LASER), as well as water flooding and steam flooding processes. SADG Steam assisted gravity drainage typically involves high temperature high-pressure steam being sent below ground to recover hydrocarbons. When the fluid returns to the surface, some of the heat has dissipated, and some is utilized in processing operations, but there still remains a large amount of waste heat that is released to the environment without further utilization. Initial heating of fluid may be accomplished using natural gas, either purchased or derived from on-site sources.

Certain thermal operations requiring water re-use may have no immediate heat sink available for re-use of heat generated in the operation. Thus, low grade waste heat generated by the operation is typically discharged to the atmosphere. For example, a conventional CSS or SAGD operation may produce in the order of 30 MW of waste heat when hot glycol (60-80° C.) produced in the operation is cooled to about 30° C. In current economic terms, this quantity of waste heat translates into approximately 5 million Canadian dollars per year.

Bitumen mining operations, such as those carried out on the oil sands in Alberta, Canada, produce heated tailings contained in a hydrocarbon solvent/water mixture. A Tailings Solvent Recovery Unit (TSRU) can be used to separate and recover an initial amount of solvent from bitumen tailings, but still produces a waste stream containing residual heat and water. There is no effort currently being made to recover water or heat from tailings as found in such a waste stream.

Canadian Patent No. 1,027,501, issued Mar. 7, 1978, describes a method for recovery of solvent from the tailings of a tar sand hot water plant, derived from centrifugal separation of diluted bitumen. A flash vacuum vessel, maintained at 3.5 psia (24 kPa) is used to separate a naphtha/water mixture from tailings solids. Subsequently, the naphtha is recovered for re-use, and the water is discarded into a settling pond.

U.S. Pat. No. 6,358,403, issued Mar. 19, 2002, describes a process for recovery of hydrocarbon solvent from tailings from bitumen froth treatment. A flash vacuum vessel maintained at a pressure of 35 kPa is used, and steam is injected directly into the liquid pool within the vessel to promote vaporization of the hydrocarbon solvent for recovery.

U.S. Pat. No. 4,561,965, issued Dec. 31, 1985, describes a process for recovery of heat and water from waste streams resulting from a hot water bitumen extraction. As the hot water bitumen extraction does not involve a solvent or hydrocarbon diluent, the recovery of water is simply effected by absorbing water vapor into a stream of air and subsequently condensing moisture from the warm vapor/air stream. In order to recover heat, heated water condensed from the vapor is directed to re-use in the process, with no provision to capture the condensed liquid as a separate stream. Where significant solvent or diluent is used in the bitumen extraction process, the process described may not be applicable for recovering either water or heat due to flammability risks.

In thermal operations, boilers are used for heating purposes. Boiler water must meet strict quality standards depending on the type of steam generation equipment, but in general should be adequately free of dissolved oxygen and minerals.

There may be environmental restrictions placed on bitumen or heavy oil recovery operations that utilize fresh water. These restrictions relate to the amount of fresh water that can be removed from a source in the environment of the operation, such as from a lake, river or fresh water aquifer. In some instances, the amount of fresh water that can be withdrawn may be a rate-limiting factor in the overall production of the operation. In such an instance, efficient re-use of water can directly impact the production of an operation.

There is a need for technologies which capture and re-use water so as to minimize input of fresh water. In thermal operations, it is desirable to provide such water for re-use at or near distilled quality for use as boiler feedwater. In doing so, corrosion and scaling of heat exchange surfaces is minimized, and the need to access fresh water sources is reduced.

It is, therefore, desirable to provide a method and a system capable of obtaining and recovering waste heat and wastewater from either or both a thermal recovery process and/or a bitumen extraction process using vacuum technologies for preparation of boiler feedwater.

### SUMMARY OF THE INVENTION

It has been found that water used in thermal methods of hydrocarbon recovery and/or bitumen mining can advantageously be recovered in relatively high purity for re-use. Further, heat can be recovered simultaneously and optionally re-directed to facilitate purification of water. Water of near distilled purity can be obtained suitable for use as boiler feedwater. This advantageously results in economic benefit attributable to water conservation and reduced energy use, and may allow higher overall production from a thermal operation in those instances where water requirements limit overall production.

In a first aspect described herein, there is provided a method of recovering high quality water from a thermal hydrocarbon recovery operation. The method comprises accessing a hot water stream produced in a thermal hydrocarbon recovery operation; vapourizing water from the water stream by applying a vacuum, thereby producing water vapour; and condensing the water vapour to produce high quality water.

Further, there is provided a system for recovering high quality water from a thermal hydrocarbon recovery operation. The system comprises a hot water intake interfacing with a hot water stream from a thermal hydrocarbon recovery operation; a vapourization module receiving the hot water stream from the hot water intake, comprising a vacuum chamber in which a vacuum is applied to produce water vapour from the hot water stream; a condensation module in which water vapour produced in the vapourization module is condensed to form high quality water; and a water outlet for releasing the high quality water from the condensation module for re-use within the thermal hydrocarbon recovery operation. Optionally, the vapourization module and condensation module may be combined into one unit.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures.

FIG. 1 is a schematic representation of the method described herein.

FIG. 2 is a schematic representation of the system described herein.

FIG. 3A is a schematic illustration of a heat and water recovery system for an existing thermal recovery operation in which water is initially derived from a skim tank or secondary deoiling system such as an Induced Gas Floatation (IGF) unit.

FIG. 3B is an illustration of an additional system that can be incorporated into the system depicted in FIG. 3A, wherein cold water is heated and prepared for use as boiler feedwater.

FIG. 4 is a schematic illustration of a system that derives heat from Hot Lime Softener (HLS) sludge or other wastewater streams.

FIG. 5 illustrates a system for treatment of SAGD water (with the optional addition of tailings) for preparation of a high quality boiler feedwater, while reusing waste heat.

FIG. 6 is a schematic depiction of a system for treatment of SAGD produced water using Multi-Stage Flash (MSF) vacuum vessels, the produced water being optionally commingled with tailings derived from a bitumen mining operation.

FIG. 7 illustrates a system in which Multi-Stage Flash is used to purify SAGD produced water. Tailings from a bitumen mining operation are subjected to vacuum in separate flash vacuum vessels so as to recover solvent for re-use prior to commingling with SAGD produced water.

FIG. 8A is a schematic illustration of a heat and water recovery system for an existing thermal recovery operation in which water is initially derived from a skim tank and/or secondary deoiling equipment.

FIG. 8B is an illustration of an additional system that can be incorporated into the system depicted in FIG. 8A, wherein cold water is heated and prepared for use as boiler feedwater.

It should be noted that the figures are merely exemplary of several embodiments of the present invention and no limitations on the scope of the present invention are intended thereby. Further, the figures are generally not drawn to scale, but are drafted for purposes of convenience and clarity in illustrating various aspects of the invention.

### DETAILED DESCRIPTION

Generally, the present invention provides a method and system for heat recovery and water recovery from thermal hydrocarbon recovery operations and/or from bitumen mining operations.

In the method and system described herein, established methodologies such as Multi-Effect Distillation (MED) or Multi-Stage Flash (MSF) processes, common to the desalination industry, can be used to treat water derived from thermal recovery operations which optionally may be combined with water derived from tailings of a bitumen mining operation, such as tailings from a Tailings Solvent Recovery Unit (TSRU). Heat can be recovered and re-used in preparation of water of a desirable purity. Such water can be produced at near distilled quality and can be used as boiler feedwater (BFW). Advantageously, embodiments of the invention provide a heat sink that utilizes waste heat from a thermal recovery operation, for example, glycol heaters may optionally be used to heat water when required to process water to a higher level of purity.

The term “thermal hydrocarbon recovery operation” as used herein refers to any hydrocarbon recovery operation wherein heat energy is imparted to the hydrocarbons including, for example: steam assisted gravity drainage (SAGD); solvent assisted SAGD; cyclic steam stimulation (CSS); combined steam and vapor extraction process (SAVEX); steam flood; steam drive; solvent assisted CSS (such as Liquid Addition to Steam for Enhanced Recovery or: LASER); or an in situ combustion operation. An example of SAGD is described in U.S. Pat. No. 4,344,485 (Butler). An example of SAVEX is described in U.S. Pat. No. 6,662,872 (Gutek). An example of CSS is described in U.S. Pat. No. 4,280,559 (Best). An example of LASER is described in U.S. Pat. No. 6,708,759 (Leaute et al.). SAGD and CSS are exemplary types of recovery operations that will be discussed in more detail herein. A hot water stream produced in thermal hydrocarbon recovery operation may be produced from any bitumen recovery process that results in the generation of a process-affected water.

The term “high quality water” as used herein is meant to encompass water of a purity that is at or near the purity and quality of distilled water, thus making the high quality water acceptable for use as boiler feedwater (BFW).

A method of recovering high quality water from a thermal hydrocarbon recovery operation is described. The method involves accessing a hot water stream produced in a thermal hydrocarbon recovery operation, and vapourizing water from the water stream by applying a vacuum, thereby producing water vapour. The water vapour is then condensed to produce high quality water.

The hot water stream may be produced by steam assisted gravity drainage (SAGD); solvent assisted SAGD; cyclic steam stimulation (CSS); combined steam and vapor extraction process (SAVEX); steam flood (or variant); steam drive; solvent assisted CSS (such as Liquid Addition to Steam for Enhanced Recovery or: LASER); an in situ combustion operation or any other thermal process utilizing water. The hot water stream may be derived from a skim tank, from induced gas floatation (IGF), induced static flotation (ISF); or from free water knock out (FWKO), electrostatic treaters or similar deoiling equipment. Separation aids may be added to the wellbore effluent, and will vary; but could be a naphthenic or paraffinic solvent, or simply a lower density hydrocarbon.

The hot water stream resulting from these recovery processes may have a temperature range from 80 to 250° C.

Vapourizing water by applying a vacuum may comprise application of a single or multi-stage flash (MSF) or by multi-effect distillation (MED). Vapourizing water may comprise application of a vacuum at a pressure of from 1 kPa to 50 kPa or any pressure up to a full vacuum as process conditions warrant. The vapourizing and condensation steps may be conducted within the same vessel, within a series of vessels, or may occur in separate vessels.

The step of providing the high quality water may involve providing the water to a boiler as boiler feedwater. The boiler may be a once through steam generator (OTSG) or a drum boiler. Further, a polishing step to further purify the high quality water may be conducted in order to provide a water stream suitable for boiler feed water.

When providing water to a boiler, after condensing the water, waste heat from the thermal hydrocarbon recovery operation can be used to increase the water temperature to a temperature appropriate for boiler feedwater, in order to increase efficiency. A glycol heater deriving waste heat from the thermal hydrocarbon recovery operation can be used to increase the water temperature to a temperature appropriate for boiler feedwater, which may be from 35 to 150° C., for example, from 50 to 110° C. An exemplary range appropriate for boiler feedwater is from 60 to 85° C., or more particularly from 60 to 75° C.

The vapour derived from tailings from a bitumen mining operation can be contributed to the water vapour condensed to produce high quality water. For example, the vapour derived from tailings can be obtained by applying a vacuum to the tailings.

In another embodiment, cold water may be heated and included in the step of vapourizing. The cold water may be from a source external to the thermal process, such as from any surface, subterranean or process affected water source. River water, lake water, brackish water, and sources of ground water are encompassed. Such water may be heated with a glycol heater, thereby deriving waste heat from the thermal hydrocarbon recovery operation, which would normally have been lost to the environment.

A system for recovering high quality water from a thermal hydrocarbon recovery operation is described herein. The system comprises a hot water intake interfacing with a hot water stream from a thermal hydrocarbon recovery operation; a vapourization module receiving the hot water stream from the hot water intake, comprising a vacuum chamber in which a vacuum is applied to produce water vapour from the hot water stream; a condensation module in which water vapour produced in the vapourization module is condensed to form high quality water; and a water outlet for releasing the high quality water from the condensation module for re-use within the thermal hydrocarbon recovery operation.

The hot water intake may interface with a hot water stream from steam assisted gravity drainage (SAGD), solvent assisted SAGD, cyclic steam stimulation (CSS), combined steam and vapor extraction process (SAVEX); steam flood (or variant); steam drive; solvent assisted CSS (such as Liquid Addition to Steam for Enhanced Recovery or: LASER) or an in situ combustion operation or any thermal process utilizing water. When the intake derives water from an in situ thermal recovery process, the hot water stream may be from a skim tank, from induced gas floatation (IGF), or from free water knock out (FWKO), electrostatic treaters or similar deoiling equipment. The hot water stream may have a temperature of from 80 to 220° C.

The vapourization module may comprise a single stage flash vacuum chamber, or may be combined with the condensation module, for example, in a multi-stage flash (MSF) unit or multi-effect distillation (MED) unit.

The water outlet from the condensation module can release water of a desired purity, such as of near distilled quality, as is advantageously used for boiler feedwater.

Optionally, the water derived from the outlet may be heated by a heater utilizing waste heat from the thermal hydrocarbon recovery operation. This may be desirable in order to warm the high quality water temperature to a temperature appropriate for boiler feedwater. A glycol heater, utilizing what would have otherwise been wasted heat from the thermal recovery process, can be used to heat water to an appropriate temperature, which may be from 35 to 150° C., for example, from 50 to 110° C. An exemplary range appropriate for boiler feedwater is from 60 to 85° C., or more particularly from 60 to 75° C.

The system may involve vapourizing water by applying a vacuum at a pressure of from 1 kPa to 50 kPa, for example at 6 kPa.

As a further option, vapour derived from TSRU tailings, resulting from bitumen mining and extraction processes, can be contributed to the vapourization module or to the condensation module. Depending on the proximity of the bitumen mining operation to the thermal recovery operation, these tailings may be hot, for example, greater than 50° C., and thus the vapour can be drawn off more readily. A vacuum can be applied to the tailings in order to facilitate vapour to leave the tailings slurry.

Another option comprises using a heater, such as a glycol heater, in the system to apply waste heat to warm cold water to provide to the vapourization module. Such a coldwater heater may be applied to any surface, subterranean or process affected water source.

The system may include a combination of exemplary options in which the hot water intake interfaces with a hot water stream derived from induced gas floatation of a SAGD operation; the vapourization module comprises a vacuum vessel at about 6 kPa and 35° C.; and the condensation module comprises a condenser deriving vapour from the vacuum vessel; and a glycol heater is used to heat high quality water arising from the condenser to a temperature of 60 to 75° C.

Alternatively, the system may include a combination of exemplary options in which the hot water intake interfaces with a hot water stream derived from FWKO, at a temperature of about 110° C.; a filter or separation system is included to remove or filter out oil and particulate from the hot water stream derived from FWKO; and the vapourization module and the condensation module are combined within a multi-effect distillation (MED) unit having pressures progressively decreasing to about 6 kPa at about 35° C.

As another exemplary system, the following options may be combined: the hot water intake interfaces with a hot water stream from SAGD produced water (PW); the vapourization and condensation modules are combined within a multi-stage flash (MSF) unit; and a tailings input is provided, which derives tailings of a bitumen mining process for inclusion in the MSF unit, so that vapour produced from the tailings can be recovered.

Advantageously, thermal recovery operations resulting in excess heat being produced, include SAGD, solvent-assisted SAGD, CSS, combined steam and vapor extraction process (SAVEX), steam flood (or variant), steam drive, solvent assisted CSS, Liquid Addition to Steam for Enhanced Recovery (LASER), or in situ combustion operations, may utilize waste heat, re-use water, and produce a high quality of water suitable for boiler feedwater use. Heat and water can be recovered instead of being lost to the environment.

In order for both heat and water from a thermal operation and a bitumen mining operation to be recovered simultaneously, the locations of the thermal operation and bitumen mining operations need not be immediately adjacent to each other, provided that the two operations are appropriately located to allow transportation of fluids or tailings from one location to another. When the thermal operation and the mining operation are located at a distance from each other, practical considerations for heat recovery will include the amount of heat loss experienced over the distance a fluid or tailings are required to travel, as well as the energy and infrastructure required to permit travel of fluid over the requisite distance. The amount of insulation in the pipeline used for transferring heated fluids between operations can be a factor that renders the integrated system practical when there is a long distance between operations. Other unpredictable economic factors, such as fluctuations in the cost of purchased natural gas or purchased water, may also be taken into consideration when considering the practical cost savings realized by recovering heat or water from both operations at a single consolidated site. Of course, recovery operations described herein can be conducted at separate locations, and need not be combined.

Components may be used in the system and method described herein which are conventionally used in desalination processes. A distinction between water resulting from desalination and produced water that arises from the system and method described herein is that the necessary energy to create the initial process temperature conditions for desalination requires purchased energy. However, by contrast, the system and method described herein have readily available heat that would conventionally be treated as waste heat, derived from thermal recovery operations, such as from CSS or SAGD. This contributes to the overall efficiency and thus the economic feasibility of the instant method and system.

Another distinction between the instant method and desalination is that a much lower level of salt is found in produced water (PW) formed according to the invention versus in seawater utilized for desalination. The higher salt level increases the boiling point, and creates a greater risk of fouling heat exchange surfaces. The boiling point elevation is minimal in the instant method and system, when compared with that of desalination of seawater. Other significant differences include the significantly lower oxygen content, and presence of organic materials in the produced water.

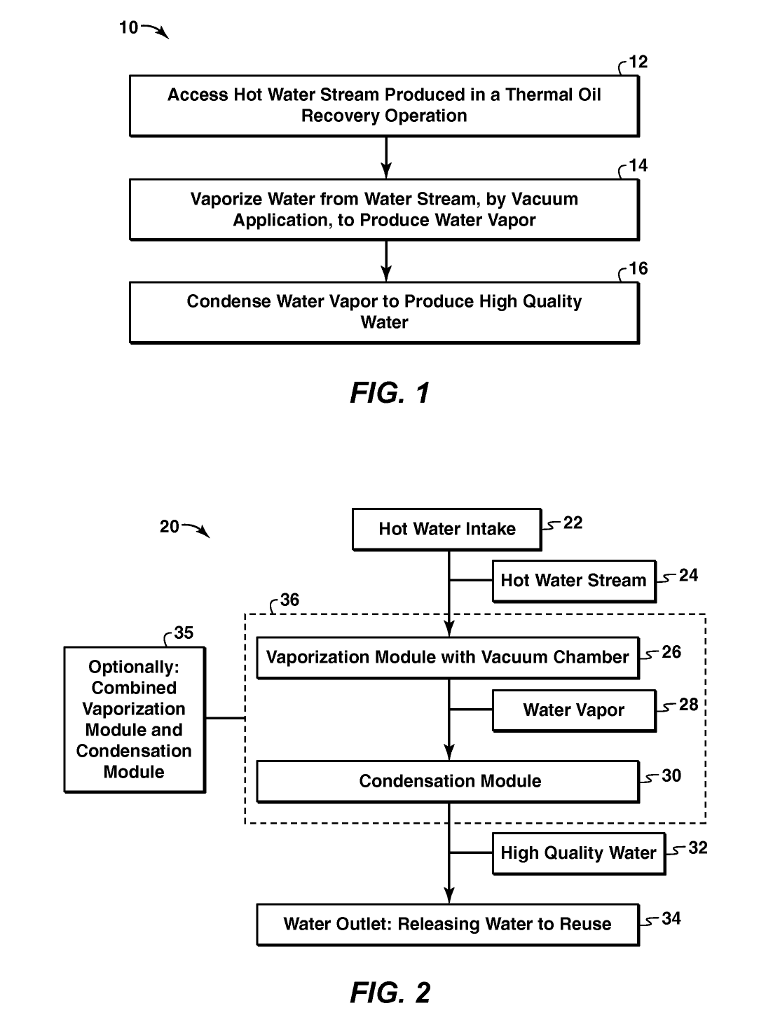

FIG. 1 illustrates a flow chart of the main steps of the method 10 of recovering high quality water from a thermal hydrocarbon recovery operation. Initially, a hot water stream is accessed 12, the stream being produced in a thermal hydrocarbon recovery operation. Subsequently, water is vapourized 14 from the water stream through the application of a vacuum, thus producing water vapour. Water vapour is subsequently condensed 16 to produce high quality water.

FIG. 2 illustrates a system 20 for recovering high quality water from a thermal hydrocarbon recovery operation. The system comprises a hot water intake 22, which interfaces with a hot water stream 24 derived from a thermal hydrocarbon recovery operation (not a high quality water source), and provides this hot water stream 24 to a vapourization module 26. The vapourization module comprises a vacuum chamber in which a vacuum is applied to produce water vapour 28 from the hot water stream. Because the water entering the vapourization module is already heated from the thermal operation, extra heat need not be added to the system in order to achieve vapourization. The sub-atmospheric pressure within the vacuum chamber promotes vapourization. Water vapour 28 is forwarded to a condensation module 30 in order to condense water with a high level of purity from contaminants and solids, as may have been present in the hot water stream entering the intake 22. Notably, according to an optional embodiment, the vaporization module and the condensation module (schematically illustrated as block 35) may be combined within a single chamber, or a series of chambers, such as is the case with MSF or MED units, as will be discussed below in further detail. Here, this optional feature is depicted using a dashed line 36. High quality water 32 arising from the condensation module is released via a water outlet 34 for re-use within the thermal hydrocarbon recovery operation, or any other useful purpose in adjoining operations . An exemplary re-use of such water would be for boiler feedwater, which benefits from having a highly pure water of near distilled quality that has little dissolved gas. This limits the rate of boiler equipment and pipeline scaling and corrosion attributable to contaminants and dissolved oxygen.

### EXAMPLE 1

Heat and water recovery from CSS or SAGD operation derived from secondary deoiling equipment.

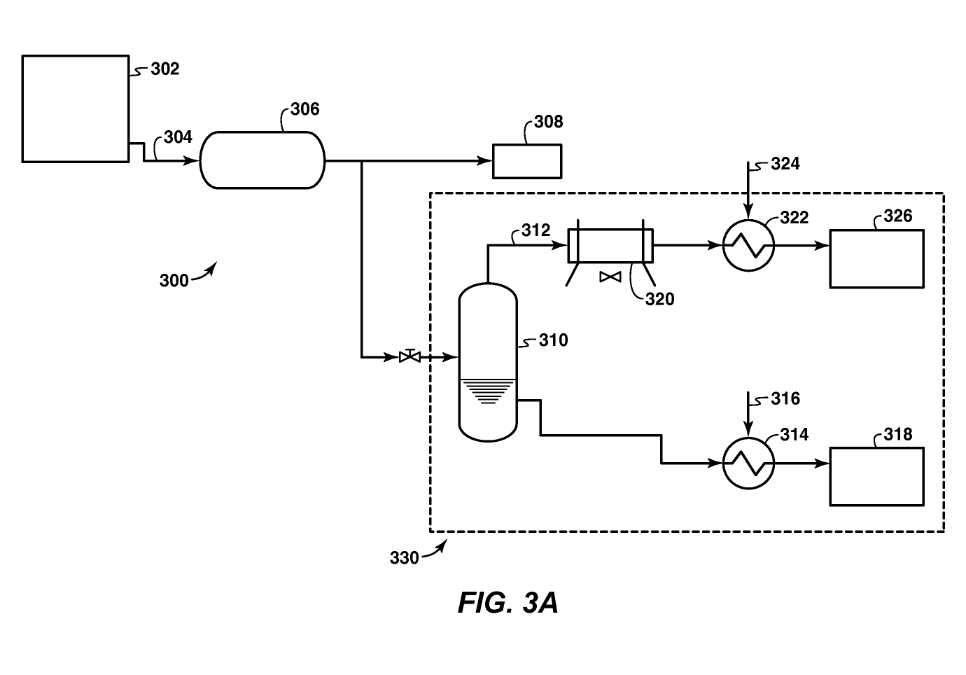

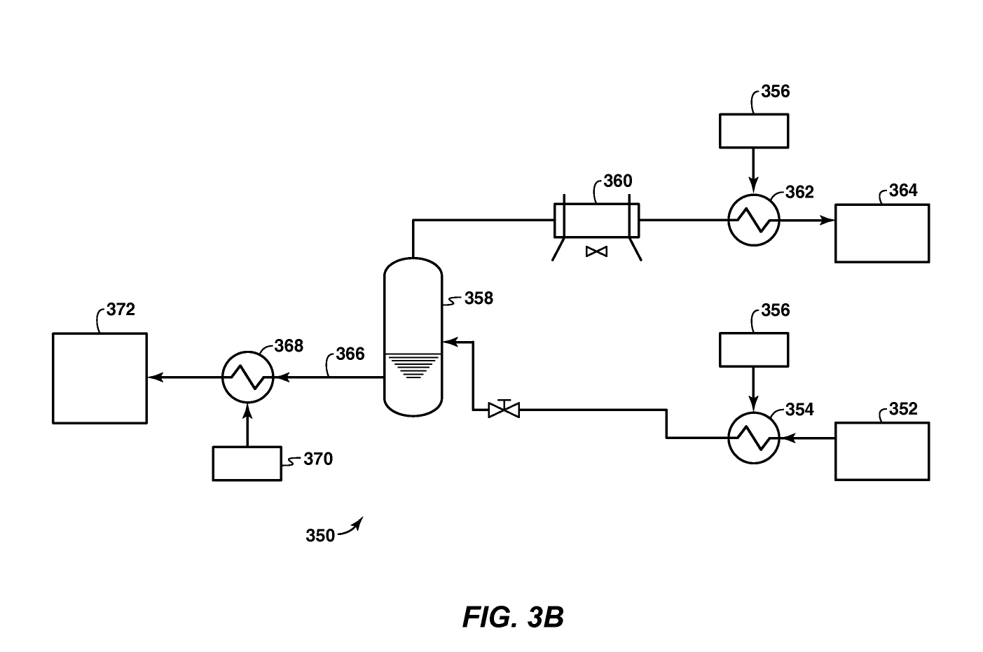

FIG. 3A is a schematic illustration of an embodiment of a heat and water recovery system. The heat and water recovery system 300 involves water derived from a skim tank 302, considered “produced water” 304, which is subsequently sent to secondary deoiling equipment 306 for additional oil removal. Such secondary deoiling equipment may comprise a gas floatation device, such as a tank. While some water is sent to lime softening 308, other proportions of water are forwarded to a vacuum vessel 310, under appropriate conditions, for example at 6 kPa, and approximately 35° C., which may be adjusted as required. A certain amount of water vapour, for example about 7.5% of the vessel inlet quantity, may be derived from the vacuum vessel vapour outlet 312, while the remaining water amount, approximately 92.5% for example, may have heat input through a glycol heater 314 into which hot glycol 316 donates heat. This can result in hot water being sent to lime softening 308 at a higher temperature, for example 80° C.

The vapour 312 may be directed to a condenser 320 to reclaim waste heat, possibly for use in heating, ventilation or air conditioning (HVAC) purposes, or discharged to atmosphere. Water exiting the condenser can have a temperature range as dictated by the condenser pressure, for instance 35° C. At this point, it may be desirable to heat the water via a glycol heater 322 into which hot glycol 324 is directed. Water so derived and heated to a level of 60-75° C. may then be used as boiler feedwater (BFW) 326, and is of adequate purity to minimize corrosion and scaling within the boiler. The components involved in the vacuum recovery cycle and waste heat utilization, as well as the lime softening (318) are depicted within a dashed border 330. It is also contemplated that instead of using lime softening 308 and 318, a single lime softening 308 could be used, in which case the flow leaving 314 could be processed in lime softening 308.

FIG. 3B is a schematic illustration of a system 350 that may be used in addition to the system depicted in FIG. 3A. The treatment of water using this system can provide water to boilers in such a way as to “debottleneck” the production of high quality water for boiler feedwater (BFW). Specifically, cold water 352 which may be derived from a surface, subterranean or process affected water source, is obtained at a temperature of about 5° C. Through a glycol heat exchanger 354 deriving heat from hot glycol 356 produced for example in SAGD, the water is heated to about 80° C., and provided to a vacuum process 358 in which water is exposed to a single or multi-stage flash vacuum vessel(s) or MED system. The water vapour recovered from the chamber can be condensed at the condenser 360 and can go on to further heating with hot glycol 356 in a glycol heat exchanger 362. Depending on process conditions, the condenser heat sink could be air, or cold water 352 prior to being heated in exchanger 354, or a combination thereof. From here, the water is of adequate quality to be used as boiler feedwater (BFW) 364. Water that results from the vacuum process in non-vapour form 366 can be heated using a glycol heat exchanger 368, accessing hot glycol 370 for processing purposes 372 other than BFW, in which distilled quality water is not a requirement. High quality BFW 364 produced can go on to supplement BFW 326 in FIG. 3A.

Advantageously, a heat sink is created by flashing produced water to a cooler temperature within the vacuum vessel. The water vapour that is produced can be condensed by heat exchange, with atmosphere, or in situations warranting other methods of heat exchange, cold water may be used, such as river water, for condensation, having the additional advantage of heating water that may be required, such as when the system is integrated with a bitumen mining operation located nearby a source of river water. The cold processed water can be reheated with waste heat formed elsewhere in the system, such as the waste heat resulting from a thermal recovery operation, which produces hot glycol at a temperature of about 80° C. Reheated water in such a system may be sent to another destination for softening. There may also be some chemical and/or energy saving when this water is softened as compared with water from other sources, due to this water being completely degassed by the time it is softened, for example in a Hot Lime Softener (HLS).

An exemplary plant housing a thermal operation may have 30 MW of waste heat at 60 to 80° C., as well as 26,000 m³/d of 80° C. water directed to HLS. Should half of this water, 13,000 m³/d, be diverted to a vacuum vessel, about 1000 m³/d of distilled water would be produced. This water may be used directly as boiler feedwater or sent for final polishing if required. In this exemplary calculation, 12,000 m³/d of water would then be produced at 35° C., which can then be warmed by waste glycol (available at about 80° C. as a result of thermal recovery process) using about 26 MW of heat that would otherwise have been wasted. The net result of this exemplary calculation is that 1000 m³/d of distilled or high quality water that may not require secondary polishing is produced from waste heat, plus the remaining 12,000 m³/d of water is forwarded to the primary softening process and 26 MW of otherwise wasted heat is captured. An exemplary softening process may be HLS, but other softening processes may be used. Depending on water availability in the region or due to regulatory requirements, this re-use of water represents a significant economic efficiency.

### EXAMPLE 2

Heat capture from Hot Lime Softener sludge, Ion Exchanger Regeneration or other waste streams.

Waste streams from water softening are usually present at or near 80° C. Products from waste streams can undergo vacuum treatment to recover water and provide a heat sink for the energy conventionally wasted in the form of hot glycol derived from thermal recovery operations.

Additional advantages may be realized because the quantity of water recycled back into the pond system is reduced. The pond system oxygenates the water, and this dissolved gas gives rise to corrosion problems in process equipment prior to the degassing stage.

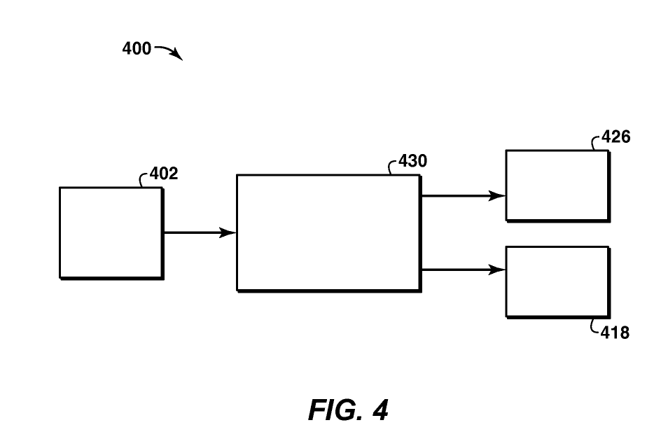

FIG. 4 is a schematic representation of a further embodiment of the system described herein. The system 400 involves deriving a waste stream 402 for recovery, for example, from the sludge pond of the HLS process, from ion exchanger regeneration, or from another type of waste stream, and directing it to vacuum treatment 430, such as described in the vacuum recovery cycle 330 of FIG. 3A, thereby producing boiler feedwater 426 and water for softening 418.

### EXAMPLE 3

SAGD produced water treatment (optionally including TSRU tailings) by Multi-Effect Distillation (MED).

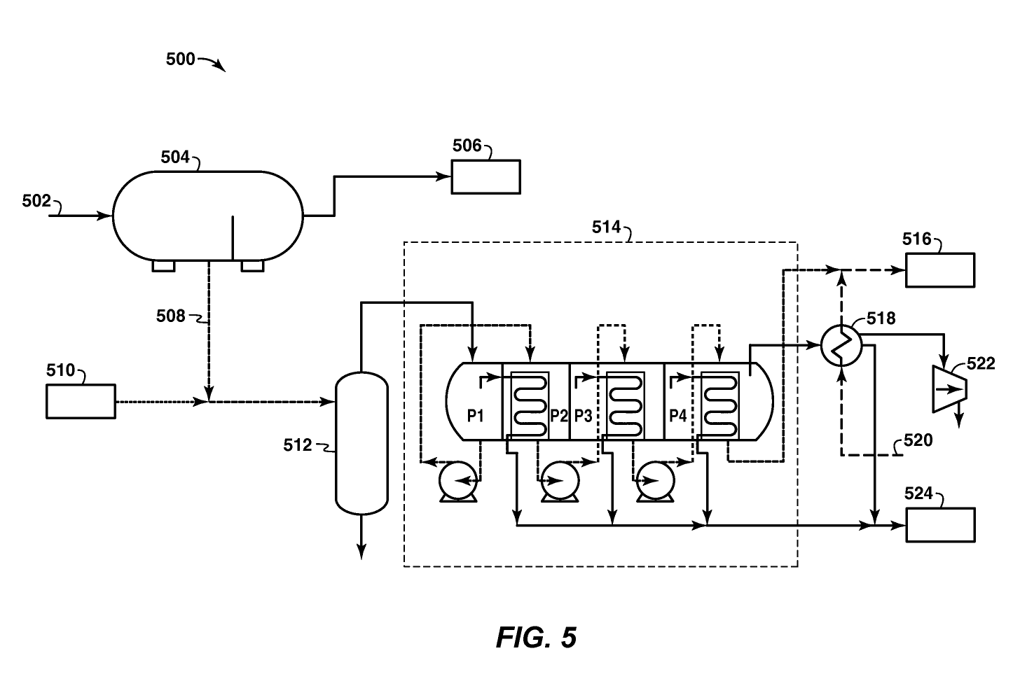

FIG. 5 illustrates an exemplary system in which the SAGD product is utilized to derive waste heat and re-use wastewater. In this example, the system 500 produces distilled water of adequate purity for boiler use, while warm water may be produced for use in bitumen extraction. SAGD production 502 which may have chemical separation aids added, is initially separated into oil and water streams using such a method as, but not excluded to Free Water Knock Out (FWKO) 504, producing wet bitumen (and separation aids) 506 that goes on to further processing and near deoiled water 508 at a temperature of approximately 110° C.

Optionally, hot tailings 510 derived from bitumen mining or other mining solvent recovery processes (if available and/or required) and processing may be combined with the near deoiled water. The water is then directed to oil removal filters 512 for oil and particulate removal. The filter allows de-oiling sufficient to avoid fouling of heat transfer surfaces. Water derived from the filters is then directed to an MED unit 514, and at this point may be at about 100° C., which is hot enough that no additional thermal energy is required in the MED unit. Within the MED unit depicted, four different pressure regions are established (P1 to P4), having descending levels of pressure, and resulting in P4 having about 6 kPa of pressure at 35° C. The final pressure within the unit is determined by the desired final temperature of the water streams produced. For example, if a higher temperature is desired, a higher pressure will result. Within the MED unit, the hot water is flashed to a lower pressure in a first stage. Liquid is again flashed to a lower pressure into the second stage. The lower temperature liquid is used to condense the vapour from the previous state, and thus undergoes heat addition so that more evaporation takes place.

Upon exiting the MED unit, one stream of warm water produced 516, considered “concentrated water”, may be sent to a mining operation at a temperature of about 35° C., or is suitable for conventional water softening procedures, if it is not desirable to provide the water to a mining operation. The other stream of water arises as vapour and can be condensed, at late stage condenser 518, having a cold water input 520 and a vacuum pump 522, and is able to provide distilled water 524 for applications requiring high water purity. In particular, this water recovered is of the quality required and suitable for boiler feedwater use.

The method and system described in this example have several advantages over conventional desalination: there is no requirement for external heat addition to the inlet stream, the recovered heat may used to offset energy purchases rather than discharged back to the environment (sea), and there is only a small amount of elevation of the boiling point, since salt concentration is not elevated to the extent seen in seawater.

This example may be implemented in several ways. For example, by using high feed temperature (e.g. 100° C.) for the Produced Water (PW) arising from the FWKO, a recovery of high quality water of approximately 15% is possible. It is also possible to include other process water streams, as would be known to those skilled in the art, such as Once Through Steam Generator (OTSG) streams, or package-boiler blowdown streams. The use of high temperature boiler blowdown streams in the application described above results in the recovery of high purity of approximately 58% of the inlet flow.

### EXAMPLE 4

Multi-stage Flash of SAGD Produced Water (PW), optionally including TSRU tailings, for heat recovery to a Mining Operation.

In this example, a Multi-Stage Flash (MSF) unit may be used to purify water derived from SAGD. Optionally, if desirable and practicable, tailings derived from TSRU as a result of a mining operation, may be included and water recovered from both the PW and tailings for re-use of the heated water. Advantageously, in this example, water derived from the SAGD process need not come into contact with solids from tailings (if used), in the system and method.

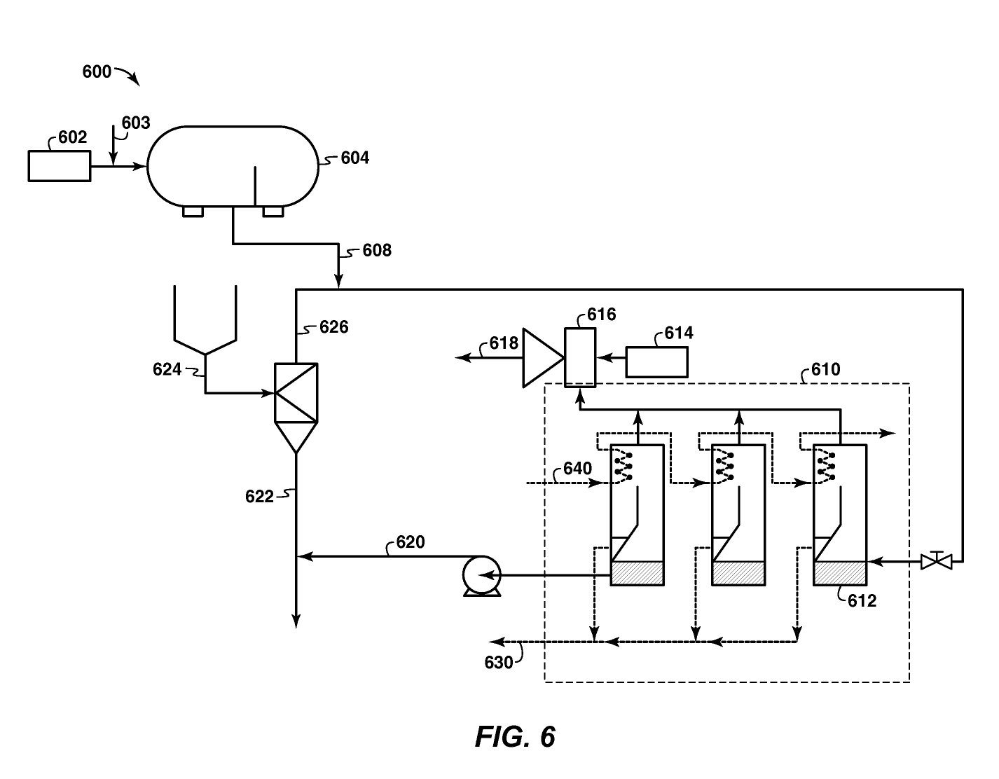

FIG. 6 is a schematic depiction of an embodiment of a system 600 for production of clean water with concomitant heating of cold water. Fluid 602 derived from SAGD production at about 150 to 220° C. is directed to a separation vessel 604. Process separation aids, such as solvents or other chemicals, may be added (603) prior to the separation vessel. The vessel produces a separated SAGD Produced Water (PW) stream 608. This PW goes on to access a Multi-Stage Flash (MSF) procedure 610 (encompassed by a dashed line), from which non-condensable gas evolves.

In this case, MSF is depicted with three separate tanks 612, although more or fewer tanks may be used in MSF. The MSF procedure creates a vacuum in which water vapour is produced. The vapour is condensed, giving up the heat from the phase change to heat a coldwater source 640, such as cold pond or river water destined for bitumen extraction, thus capturing heat that would otherwise be lost to the environment. High quality water 630 is obtained from the condensation section of the vessels, and made available for any process requiring water of this purity, such as steam generation.

MSF tanks are used in a manner conventionally prescribed so that vapour is created due to the vacuum produced from a vacuum pump or steam ejector 616, to which low pressure steam 614 is provided. Low pressure steam vapour from outlet 618 is later condensed via a condenser downstream of non-condensable gas outlet 618. Water 620 that remains from each stage of the multi-stage flash procedure is processed through the next stage, and finally discharged, but can be used to intermingle with the solids 622 which may have been removed from TSRU tailings 624, if these were included in the system.

When TSRU tailings are included in the system, they may be at about 85° C., and may contain 80% water, 10% solids, and 10% asphaltenes. In this instance, there may be a solids separation step, such that only the liquid 626 from the tailings is input into MSF, which avoids any difficulties arising from processing solids from tailings. When TSRU tailings are used, there is the added advantage that the MSF procedure allows recovery of any solvent losses from the solvent recovery process (from which the tailings were derived).

In this Example, if solvent recovery losses are high, a modified system or method could be used in which TSRU tailings are exposed to a vacuum without any particle separation, and are not commingled with SAGD water until after an initial solvent recovery step. This would allow an initial amount of solvent recovery to occur prior to MSF processing.

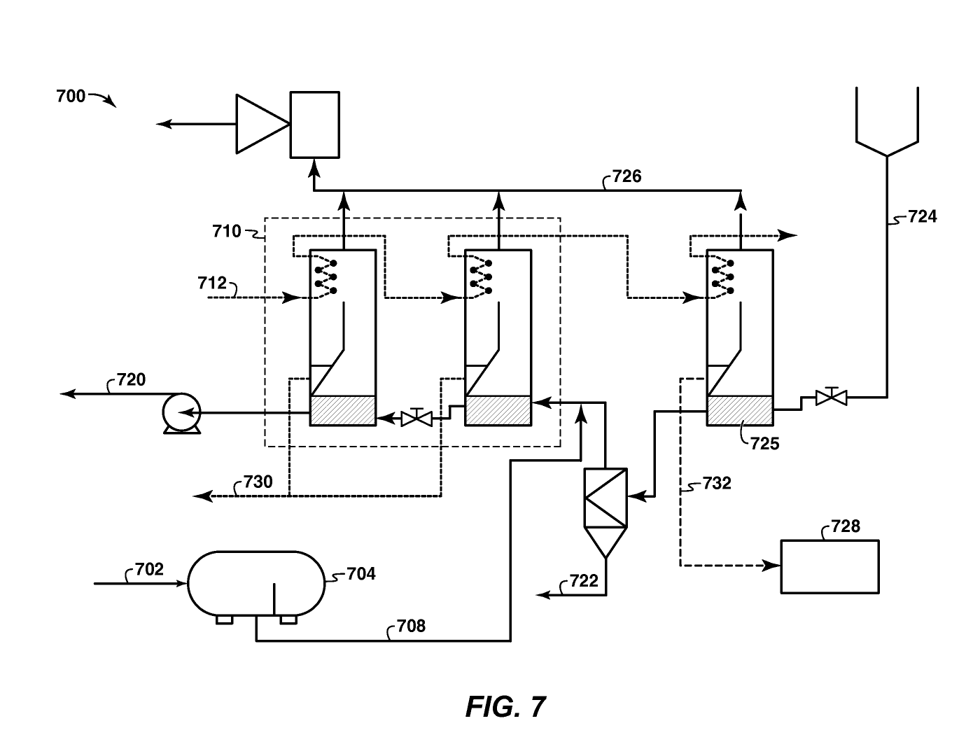

FIG. 7 illustrates an exemplary system 700 that has been modified so that TSRU tailings are initially treated separately from the PW arising from SAGD FWKO. This figure is described herein primarily with reference to the distinctions over the system 600 illustrated in FIG. 6. Briefly, water derived from FWKO 704 permits production of PW. PW 708 goes on to access an MSF process 710 encompassed by a dashed line. In this case MSF for the PW is depicted as having two tanks fed by stream 712, while it is understood that more tanks could be added, as desired. TSRU tailings 724 may be processed directly in a flash tank 725, from which water and/or solvent vapour may be condensed for recovery. Wet solvent 732 (solvent and high quality water) may be recovered for re-use of each component in solvent recovery vessel 728. The remaining liquid and TSRU solids leaving the first flash vessel are separated, with the liquid component optionally commingling with the PW and entering system 710, and the solids being discharged as waste 722. Also shown are the fluid derived from SAGD production 702, separation vessel 704, separated SAGD Produced Water (PW) stream 708, high quality water 730 recovered from 710, discharge water 720 from the final stage of the multi-stage flash procedure, and non-condensable gas stream 726.

Compared with Example 3, which relates to MED, using a multi-stage flash has the advantage of no direct contact between produced water and heat transfer surfaces. As such, the heat exchange surface is not susceptible to fouling from residual oil, fine particulates, or scale.

Advantageously, other sources of water or heat may be integrated into the recovery process. For example, liquid phase blowdown from a Once Through Steam Generator (OTSG) in a SAGD system, or flue gas heat, could be captured and utilized to recover water or heat.

### EXAMPLE 5

Heat and water recovery from Thermal hydrocarbon Recovery Operation derived from secondary deoiling equipment.

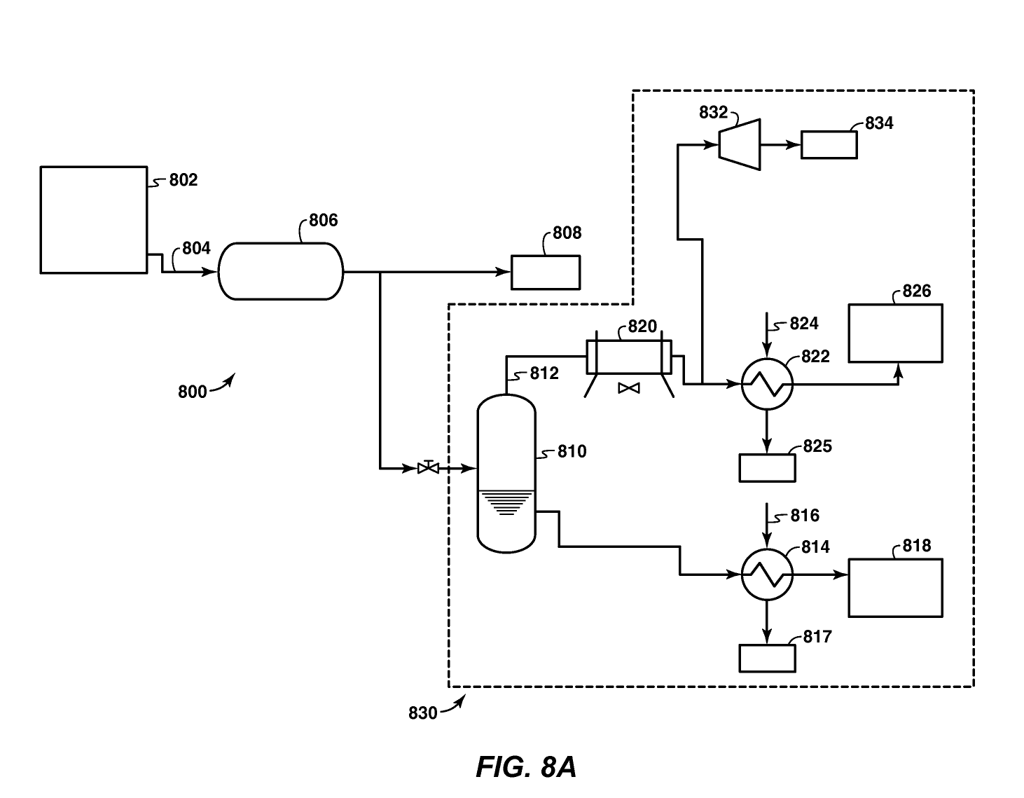

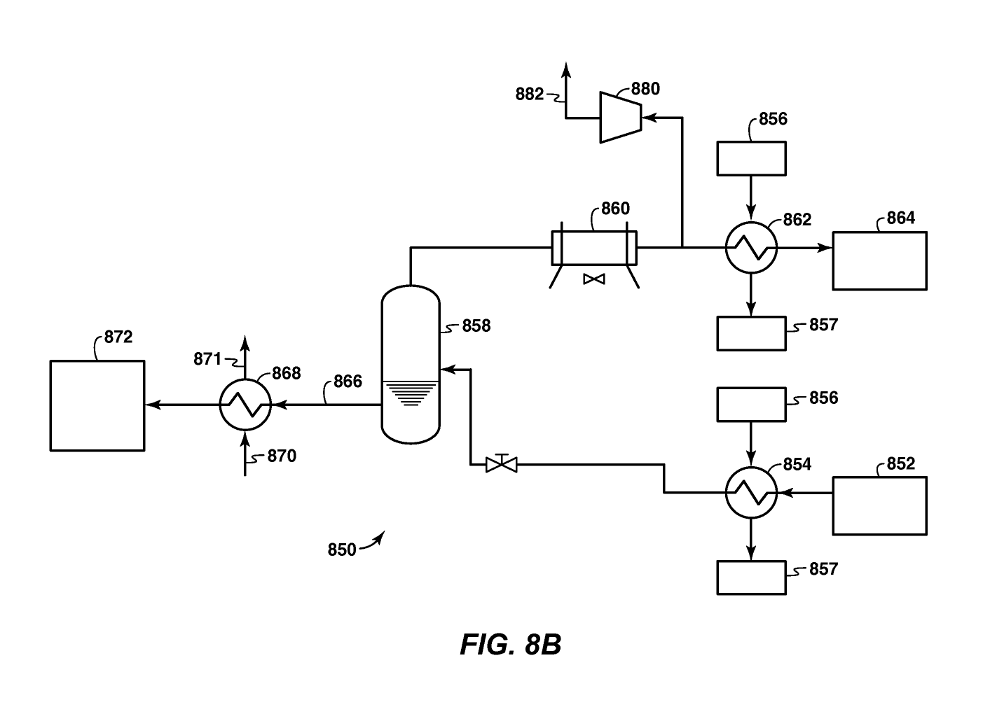

FIG. 8A is a schematic illustration of an embodiment of a heat and water recovery system. The heat and water recovery system 800 involves water derived from a skim tank 802, considered “produced water” 804, which is subsequently sent to secondary deoiling equipment 806 for additional oil removal. Such secondary deoiling equipment may comprise a gas floatation device, such as a tank. While some water is sent to lime softening 808, other proportions of water are forwarded to a vacuum vessel 810, under appropriate conditions, for example at 6 kPa, and approximately 35° C., which may be adjusted as required. A certain amount of water vapour, for example about 7.5% of the vessel inlet quantity, may be derived from the vacuum vessel vapour outlet 812, while the remaining water amount, approximately 92.5% for example, may have heat input through a glycol heater 814 into which hot glycol 816 donates heat, and cool glycol 817 is produced. This can result in hot water being sent to lime softening 818 or 808 at a higher temperature, for example, 80° C.

The vapour 812 may be directed to a condenser 820 to reclaim waste heat, possibly for use in heating, ventilation or air conditioning (HVAC) purposes or discharged to atmosphere. Water exiting the condenser will be about 35° C. At this point, it may be desirable to heat the water via a glycol heater 822 into which hot glycol 824 is directed, and from which cool glycol 825 is derived. Water so derived and heated to a level of 60 to 75° C. may then be used as boiler feedwater (BFW) 826, and is of adequate purity to minimize corrosion and scaling within the boiler. The components involved in the vacuum recovery cycle and heat recovery 830 are depicted within a dashed border. A vacuum pump 832 or similar device is used to create a vacuum within the vacuum recovery cycle 830, with non-condensable gas discharge 834 being derived therefrom.

FIG. 8B is a schematic illustration of a system 850 that may be used in addition to the system depicted in FIG. 8A. The treatment of water using this system can provide water to boilers in such a way as to “debottleneck” the production of high quality water for boiler feedwater (BFW). Specifically, cold water 852 which may be derived from a surface, subterranean or process affected water source, such as a river, a lake or other groundwater, is obtained at a temperature of about 5° C. Through a glycol heat exchanger 854, deriving heat from hot glycol 856 (produced for example as a waste heat stream as part of an in situ recovery process such as SAGD), and releasing cool glycol 857, the water is heated to about 80° C., and provided to a vacuum process 858 in which water is exposed to a single or multi-stage flash vacuum vessel(s) or MED system. The water vapour recovered from the chamber can be condensed at the condenser 860 and can go on to further heating with hot glycol 856 in a glycol heat exchanger 862, resulting in release of cool glycol 857. From here, the water is of adequate quality to be used as boiler feedwater (BFW) 864. Water that is not vaporized in the vacuum process 866 can be heated using a glycol heat exchanger 868, accessing hot glycol 870 for processing purposes 872 other than BFW, in which distilled quality water is not a requirement. Cool glycol 871 is released from the glycol heat exchanger 868. High quality BFW 864 produced can go on to supplement BFW 826 in FIG. 8A. A vacuum pump 880 or similar apparatus can be incorporated into the system to maintain vacuum pressures, releasing a non-condensable gas discharge 882. In this example, heat released from hot glycol to the environment is minimized, with concomitant production of high quality water

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A method of recovering high quality water from a thermal hydrocarbon recovery operation, the method comprising:
accessing a hot water stream produced in a thermal hydrocarbon recovery operation;
vapourizing water from the water stream by applying a vacuum, thereby producing water vapour; and
condensing the water vapour to produce high quality water.

2. The method of claim 1, wherein the hot water stream is produced by steam assisted gravity drainage (SAGD); solvent assisted SAGD; cyclic steam stimulation (CSS); combined steam and vapor extraction process (SAVEX); steam flood; steam drive; solvent assisted CSS; Liquid Addition to Steam for Enhanced Recovery (LASER); or an in situ combustion operation.

3. The method of claim 2, wherein the hot water stream is produced by SAGD.

4. The method of claim 3, wherein the hot water stream is derived from a skim tank, from induced gas flotation (IGF), induced static flotation (ISF); free water knock out (FWKO), electrostatic treaters or deoiling equipment.

5. The method of claim 1, wherein the hot water stream has a temperature of from 80 to 250° C.

6. The method of claim 1, wherein vapourizing water by applying a vacuum comprises application of a single or multi-stage flash (MSF) or by multi-effect distillation (MED), or a combination thereof.

7. The method of claim 1, additionally comprising the step of providing the high quality water to a boiler as boiler feedwater.

8. The method of claim 7, wherein the boiler is a once through steam generator (OTSG) or a drum boiler.

9. The method of claim 1, comprising a polishing step to further purify the high quality water to produce a water stream suitable for a boiler.

10. The method of claim 9, wherein after condensing the water, waste heat from the thermal hydrocarbon recovery operation is used to increase the water temperature.

11. The method of claim 10, wherein a glycol heater deriving waste heat from the thermal hydrocarbon recovery operation is used to increase the water temperature.

12. The method of claim 10 [or 11,]wherein the temperature is increased to a range from 35 to 150° C.

13. The method of claim 12, wherein the temperature is from 60 to 85° C.

14. The method of claim 1, wherein vapourizing water comprises applying a vacuum at a pressure of from 1 kPa to 50 kPa.

15. The method of claim 1, wherein vapour derived from tailings from a bitumen mining operation is contributed to the water vapour condensed to produce high quality water.

16. The method of claim 15, wherein the vapour derived from tailings is obtained by applying a vacuum to the tailings.

17. The method of claim 1, additionally comprising heating cold water to be included in the step of vapourizing.

18. (canceled)

19. The method of claim 1 wherein a heat sink for condensation is provided by cool water destined for one or more processes requiring warmer water.

20. The method of claim 17 [or 18], wherein a glycol heater deriving waste heat from the thermal hydrocarbon recovery operation is used to heat the cold water.

21. A system for recovering high quality water from a thermal hydrocarbon recovery operation comprising:
a hot water intake interfacing with a hot water stream from a thermal hydrocarbon recovery operation;
a vapourization module receiving the hot water stream from the hot water intake, comprising a vacuum chamber in which a vacuum is applied to produce water vapour from the hot water stream;
a condensation module in which water vapour produced in the vapourization module is condensed to form high quality water; and
a water outlet for releasing the high quality water from the condensation module for re-use within the thermal hydrocarbon recovery operation.

22. The system of claim 21, wherein the hot water intake interfaces with a hot water stream from steam assisted gravity drainage (SAGD); solvent assisted SAGD; cyclic steam stimulation (CSS); combined steam and vapor extraction process (SAVEX); steam flood; steam drive; solvent assisted CSS; Liquid Addition to Steam for Enhanced Recovery (LASER); or an in situ combustion operation.

23. The system of claim 22, wherein the hot water intake interfaces with a hot water stream from SAGD.

24. The system of claim 23, wherein the hot water stream is derived from a skim tank, from induced gas floatation (IGF), or from free water knock out (FWKO), electrostatic treaters or deoiling equipment.

25. The system of claim 21, wherein the hot water stream has a temperature of from 80 to 250° C.

26. The system of claim 21, wherein:
the vapourization module comprises a single-stage flash vacuum chamber; or
the vapourization module and the condensation module are combined as a multi-stage flash (MSF) unit or multi-effect distillation (MED) unit.

27. The system of claim 21, wherein the water outlet provides the high quality water to a boiler for boiler feedwater.

28. The system of claim 27, wherein the boiler is a once through steam generator (OTSG) or a drum boiler.

29. The system of claim 27, additionally comprising a heater utilizing waste heat from the thermal hydrocarbon recovery operation to increase the high quality water temperature to a temperature appropriate for boiler feedwater.

30. The system of claim 29, wherein the heater is a glycol heater.

31. The system of claim [28 or 30] 29, wherein the temperature appropriate for boiler feedwater is from 35 to 150° C.

32. The system of claim 31, wherein the temperature appropriate for boiler feedwater is from 60 to 85° C.

33. The system of claim 21, wherein vapourizing water comprises applying a vacuum at a pressure of from 1 kPa to 50 kPa.

34. The system of claim 21, additionally comprising a tailings input to contribute vapour derived from tailings of a bitumen mining operation to the vapourization module or to the condensation module.

35. The system of claim 34, wherein the tailings vapour input derives vapour from tailings by applying a vacuum to the tailings.

36. The system of claim 1, additionally comprising a coldwater heater for heating cold water to provide to the vapourization module.

37. The system of claim 36, wherein the cold water heated in the coldwater heater is any surface, subterranean or process affected water source.

38. The system of claim 21, wherein heat sink for condensation is provided by cool water destined for processes requiring warmer water.

39. The system of claim 36 [or 37], wherein the coldwater heater is a glycol heater deriving waste heat from the thermal hydrocarbon recovery operation.

40. The system of claim 21, wherein:
the hot water intake interfaces with a hot water stream derived from induced gas floatation of a SAGD operation;
the vapourization module comprises a vacuum vessel at about 6 kPa and 35° C.;
the condensation module comprises a condenser deriving vapour from the vacuum vessel; and
a glycol heater is used to heat high quality water arising from the condenser to a temperature of 60 to 75° C.

41. The system of claim 21, wherein:
the hot water intake interfaces with a hot water stream derived from FWKO, at a temperature of about 100 to 200° C.;
a separation system is included to remove oil and particulate from the hot water stream derived from FWKO; and
the vapourization module and the condensation module are Combined within a multi-effect distillation (MED) unit having pressures progressively decreasing to about 6 kPa at about 35° C.

42. The system of claim 21, wherein:
the hot water intake interfaces with a hot water stream from SAGD produced water (PW);
the vapourization module and condensation module are combined within a multi-stage flash (MSF) unit; and
a tailings input derives tailings of a bitumen mining process for inclusion in the MSF unit.

43. The method of claim 1, further comprising accessing a further hot water stream in a hydrocarbon mining and extraction operation and vapourizing water from the water stream by applying a vacuum, thereby producing water vapour, and condensing the water vapour to produce high quality water.

44. The system of claim 1, further comprising a further hot water intake interfacing with a hot water stream from a hydrocarbon mining and extraction operation for passing to the vapourization module.
